(19) United States
(12) Patent Application Publication
(10) Pub. No.: US 2026/0302237 A1
(43) Pub. Date: Oct. 1, 2026

(54) POSITIVE ELECTRODE ACTIVE MATERIAL FOR LITHIUM-ION SECONDARY BATTERY AND METHOD FOR MANUFACTURING SAME

(71) Applicant: HONDA MOTOR CO., LTD., Tokyo (JP)

(72) Inventors: Koji NISHIGUCHI, Saitama (JP); Yoshiyuki MORITA, Saitama (JP)

(21) Appl. No.: 19/630,484

(22) Filed: Mar. 27, 2026

(30) Foreign Application Priority Data
Mar. 31, 2025 (JP) 2025-059558

(51) Int. Cl. H01M 4/62; C01G 53/50; H01M 4/36; H01M 4/505

(52) U.S. Cl. CPC H01M 4/62; C01G 53/50; H01M 4/366; H01M 4/505; C01P 2004/61; C01P 2004/80; C01P 2006/40

(57) ABSTRACT

A positive electrode active material for a lithium-ion secondary battery according to one embodiment of the present invention includes lithium-nickel-manganese composite oxide containing lithium, nickel, and manganese, and being substantially free of cobalt, and a coating layer partially coating a surface of the lithium-nickel-manganese composite oxide. The coating layer includes boron, and the coating layer has a coverage ratio of 40% or more and 90% or less, wherein the coverage ratio is determined by X-ray photoelectron spectroscopy. A positive electrode active material for a lithium-ion secondary battery according to one embodiment of the present invention includes lithium-nickel-manganese composite oxide containing lithium, nickel, and manganese, and not including cobalt, and a coating layer coating a part of a surface of the lithium-nickel-manganese composite oxide. The coating layer includes boron, and the coating layer has a coverage ratio of 40% or more and 90% or less, wherein the coverage ratio is determined by X-ray photoelectron spectroscopy.

This application is based on and claims the benefit of priority from Japanese Patent Application No. 2025-059558, filed on 31 Mar. 2025, the content of which is incorporated herein by reference.

### BACKGROUND OF THE INVENTION

### Field of the Invention

The present invention relates to a positive electrode active material for a lithium-ion secondary battery and a method for manufacturing the same.

### Related Art

In recent years, research and development of secondary batteries that contribute to energy efficiency has been carried out in order to ensure many people have access to affordable, reliable, sustainable, and advanced energy. As positive electrode active materials for lithium-ion secondary batteries, lithium transition metal oxides including a transition metal such as nickel, cobalt and manganese as a main component are generally used. Providing a coating layer on a surface of a lithium transition metal oxide has been studied (Patent Document 1 and Patent Document 2).
Patent Document 1: Japanese Unexamined Patent Application (Translation of PCT Application), Publication No. 2023-513558
Patent Document 2: Japanese Unexamined Patent Application, Publication No. 2021-64598

### SUMMARY OF THE INVENTION

Meanwhile, in the technology related to secondary batteries, sustainability of resources is one of the problems. In respect of the lithium transition metal oxide, sustainability of cobalt is emphasized. Therefore, use of a lithium-nickel-manganese composite oxide containing lithium, nickel, and manganese, and being substantially free of cobalt as a positive electrode active material has been studied. However, lithium-nickel-manganese composite oxides tend to have lower discharge capacity as compared with lithium transition metal oxides containing cobalt.

The present invention has been made in view of the above problems, and aims to provide a positive electrode active material adapted for a lithium-ion secondary battery, including lithium-nickel-manganese composite oxide, and having an improved discharge capacity, and a method for manufacturing the same. Consequently, contribution to energy efficiency can be achieved.

The present inventors have found that the discharge capacity is improved by partially coating a surface of a lithium-nickel-manganese composite oxide with a coating layer including boron, and have completed the present invention. Accordingly, the present invention provides the followings.

(1) A positive electrode active material for a lithium-ion secondary battery, the positive electrode active material including: a lithium-nickel-manganese composite oxide containing lithium, nickel, and manganese, and being substantially free of cobalt; and a coating layer partially coating a surface of the lithium-nickel-manganese composite oxide, the coating layer including boron, and the coating layer having a coverage ratio of 40% or more and 90% or less, wherein the coverage ratio is determined by X-ray photoelectron spectroscopy.

According to the positive electrode active material for a lithium-ion secondary battery of (1), since the lithium-nickel-manganese composite oxide is substantially free of cobalt, sustainability of resources is high. Furthermore, since the surface of the lithium-nickel-manganese composite oxide is coated with the coating layer including boron at the coverage ratio mentioned above, discharge capacity is improved.

(2) In the positive electrode active material for a lithium-ion secondary battery described in (1), a content ratio of boron is 0.25% by mass or more and less than 0.75% by mass in terms of an amount of boric acid.

According to the positive electrode active material for a lithium-ion secondary battery of (2), since the content ratio of boron forming the coating layer is in the range mentioned above, the discharge capacity is reliably improved.

(3) In the positive electrode active material for a lithium-ion secondary battery described in (1) or (2), the coating layer includes boric acid.

According to the positive electrode active material for a lithium-ion secondary battery of (3), since the boric acid included in the coating layer has low reactivity and is chemically stable, the discharge capacity is improved for a long term.

(4) In the positive electrode active material for a lithium-ion secondary battery described in any one of (1) to (3), the coating layer has a thickness of 5.0 nm or more and 20.0 nm or less.

According to the positive electrode active material for a lithium-ion secondary battery of (4), since the coating layer has the thickness in the range mentioned above and is thick, the discharge capacity is improved more reliably.

(5) In the positive electrode active material for a lithium-ion secondary battery described in any one of (1) to (4), the lithium-nickel-manganese composite oxide has an average primary particle diameter of 3 μm or more and 5 μm or less.

According to the positive electrode active material for a lithium-ion secondary battery of (5), since the average primary particle diameter is in the range mentioned above and fine, the discharge capacity is increased.

(6) In the positive electrode active material for a lithium-ion secondary battery described in any one of (1) to (5), a ratio of a thickness of the coating layer to an average particle diameter of the lithium-nickel-manganese composite oxide is 0.001 or more and 0.014 or less.

According to the positive electrode active material for a lithium-ion secondary battery of (6), since the ratio of the thickness of the coating layer to the average particle diameter of the lithium-nickel-manganese composite oxide is in the range mentioned above, the electric capacity per particle of the lithium-nickel-manganese composite oxide and the thickness of the coating layer are well balanced, and the discharge capacity is further improved.

(7) In the positive electrode active material for a lithium-ion secondary battery described in any one of (1) to (6), wherein an amount of hydrochloric acid at 0.05 mol/L required to neutralize a mixture solution obtained by putting 1 g of the positive electrode active material into 50 mL of water is 1.8 mL or more and 2.9 mL or less.

(8) A method for manufacturing a positive electrode active material for a lithium-ion secondary battery, the method including calcining a mixture that contains a lithium-nickel-manganese composite oxide containing lithium, nickel, and manganese, and being substantially free of cobalt, and boric acid such that a content of boric acid is 0.25% by mass or more and less than 0.75% by mass.

According to the method for manufacturing a positive electrode active material for a lithium-ion secondary battery of (8), since a mixture containing boric acid in the range mentioned above is calcined, positive electrode active materials for a lithium-ion secondary batteries in which the surface of the lithium-nickel-manganese composite oxide is partially coated with the coating layer including boron can be industrially advantageously manufactured. Then, in the resulting positive electrode active material for a lithium-ion secondary battery, since the surface of the lithium-nickel-manganese composite oxide is coated with a coating layer including boron at the coverage ratio mentioned above, the discharge capacity is improved.

(9) In the method for manufacturing a positive electrode active material for a lithium-ion secondary battery described in (8), the mixture is calcined at a calcination temperature of 200° C. or higher and 500° C. or lower.

According to the method for manufacturing a positive electrode active material for a lithium-ion secondary battery of (9), since the calcination temperature of the mixture is in the range mentioned above, a discharge capacity of the resulting positive electrode active material for a lithium-ion secondary battery is reliably improved.

(10) in the method for manufacturing a positive electrode active material for a lithium-ion secondary battery described in (9), heating is carried out to the calcination temperature at a temperature rise rate of 5° C./minute or greater and 20° C./minute or less.

According to the method for manufacturing a positive electrode active material for a lithium-ion secondary battery of (10), since the temperature rise rate up to the calcination temperature is in the range mentioned above, the discharge capacity of the resulting positive electrode active material for a lithium-ion secondary battery is improved more reliably.

(11) In the method for manufacturing a positive electrode active material for a lithium-ion secondary battery according to any one of (8) to (10), the mixture is calcined for a calcination time of 0.5 hours or longer and 5.0 hours or shorter.

According to the method for manufacturing a positive electrode active material for a lithium-ion secondary battery of (11), since the calcination time of the mixture is in the range mentioned above, the discharge capacity of the resulting positive electrode active material for a lithium-ion secondary battery is improved more reliably.

The present invention can provide a positive electrode active material adapted for a lithium-ion secondary battery, including a lithium-nickel-manganese composite oxide, and having an improved discharge capacity, and a method for manufacturing the same.

### DETAILED DESCRIPTION OF THE INVENTION

Hereinafter, the embodiments of the present invention will be described. However, the embodiments shown below are just examples showing the present invention, and the present invention is not limited to the followings.

The positive electrode active material for a lithium-ion secondary battery of this embodiment includes lithium-nickel-manganese composite oxide, and a coating layer partially coating a surface of the lithium-nickel-manganese composite oxide.

The lithium-nickel-manganese composite oxide to be used for this embodiment contains lithium, nickel, and manganese, and is substantially free of cobalt. However, the presence of inevitable impurities is permissible. The average primary particle diameter of the lithium-nickel-manganese composite oxide may be, for example, 3 μm or more and 5 μm or less. The average primary particle diameter is an average of particle diameters of 100 primary particles, measured using SEM (scanning electron microscope).

The coating layer coating lithium-nickel-manganese composite oxide includes boron. The coating layer may be, for example, boric acid, and a thermally decomposed product of boric acid. The coverage ratio of the coating layer is 40% or more and 90% or less. The coverage ratio was calculated from the following formula by measuring a boron amount (at %), a nickel amount (at %), and a manganese amount (at %) on a surface of the positive electrode active material for a lithium-ion secondary battery by an XPS method (X-ray photoelectron spectroscopy). Note here that the coverage ratio in this embodiment is an average value of the coverage ratios measured from 100 positive electrode active materials for lithium-ion secondary batteries.

Coverage ratio (%)=Boron amount/(Boron amount+Nickel amount+Manganese amount)×100

A thickness of the coating layer may be, for example, 5.0 nm or more and 20.0 nm or less. The thickness of the coating layer was a depth at which the boron concentration was ½ in depth profiling. In other words, the thickness of the coating layer was measured as follows. The surface of the positive electrode active material for a lithium-ion secondary battery is scraped by 10 nm each by a sputtering method, and the boron concentration on the scraped surface of the positive electrode active material for a lithium-ion secondary battery is measured by an XPS method to obtain the depth profiling. From the resulting depth profiling, the depth at which the boron concentration becomes ½ of the surface concentration is determined as the thickness of the coating layer. Note here that the thickness of the coating layer of this embodiment is an average value of the thicknesses of the coating layers measured from 100 lithium-ion secondary battery positive electrode active materials.

A ratio of the thickness of the coating layer to the average particle diameter of lithium-nickel-manganese composite oxide (thickness of coating layer/average particle diameter of lithium-nickel-manganese composite oxide) may be 0.001 or more and 0.014 or less.

In the positive electrode active material for a lithium-ion secondary battery, the content ratio of boron may be 0.25% by mass or more and less than 0.75% by mass in terms of an amount of boric acid. The content ratio of boron is a value obtained as follows. A positive electrode active material for a lithium-ion secondary battery is dissolved with acid, and the boron concentration in the resulting solution is measured. The resulting boron concentration is converted into a boric acid concentration, and the boric acid content ratio of the positive electrode active material for a lithium-ion secondary battery is calculated.

For the positive electrode active material for a lithium-ion secondary battery, the amount of hydrochloric acid required to neutralize a mixed solution obtained by putting 1 g to 50 mL of water with 0.05 mol/L hydrochloric acid (making pH of the mixed solution to 7) may be 1.8 mL or more and 2.9 mL or less. The amount of hydrochloric acid corresponds to the amount of the base component (water-soluble lithium salt) remaining on the surface of the positive electrode active material for a lithium-ion secondary battery.

The positive electrode active material for a lithium-ion secondary battery of this embodiment can be manufactured by a method for calcining a mixture containing, for example, a lithium-nickel-manganese composite oxide, and boric acid such that the content of boric acid is 0.25% by mass or more and less than 0.75% by mass.

Lithium-nickel-manganese composite oxide and boric acid can be mixed by a dry method. Lithium-nickel-manganese composite oxide and boric acid can be mixed with each other using a high-speed agitator mixer.

The atmosphere in which the mixture is calcined is not particularly limited and may be an air atmosphere. The mixture may be calcinated at a calcination temperature of, for example, 200° C. or higher and 500° C. or lower, and may be 250° C. or higher and 450° C. or lower. The temperature rise rate up to the calcination temperature may be, for example, 5° C./minute or greater and 20° C./minute or less. The calcination time may be 0.5 hours or longer and 5 hours or shorter, and may be 1.0 hour or longer and 4.0 hours or shorter.

The positive electrode active material for a lithium-ion secondary battery of this embodiment can be used as a positive electrode active material of the lithium ion secondary battery. The lithium ion secondary battery includes, for example, a positive electrode, a negative electrode, an electrolytic solution, a separator disposed between the positive electrode and the negative electrode, and an outer packaging for housing them. A solid electrolyte may be used instead of the electrolytic solution.

The positive electrode includes a positive electrode current collector and a positive electrode active material layer formed on the surface of the positive electrode current collector. The positive electrode active material layer includes the positive electrode active material for a lithium-ion secondary battery of this embodiment. The positive electrode active material layer may include a conductive auxiliary agent and a binder. The conductive auxiliary agent and the binder are not particularly limited, and known conductive auxiliary agents and binders used in positive electrode active material layers of lithium-ion secondary batteries can be used. Furthermore, the positive electrode current collector is not particularly limited, and known positive electrode current collectors used in positive electrode current collectors of lithium-ion secondary batteries, such as an aluminum foil, can be used.

As the negative electrode, a laminated body including a negative electrode current collector and a negative electrode active material layer formed on the surface of the negative electrode current collector can be used. The negative electrode active material layer includes a negative electrode active material. Examples of the negative electrode active material to be used include metallic lithium, materials capable of absorbing and releasing lithium, metal or metalloid forming an alloy with lithium. Examples of materials capable of absorbing and releasing lithium include lithium transition metal oxide such as lithium titanate, transition metal oxide such as TiO₂, Nb₂O₃, and WO₃, SiO, metal sulfide, metal nitride, and carbon materials such as artificial graphite, natural graphite, graphite, soft carbon, and hard carbon. Examples of the metal or metalloid forming an alloy with lithium include Mg, Si, Au, Ag, In, Ge, Sn, Pb, Al, Zn, and the like. When the negative electrode active material is powdery, the negative electrode active material layer may include a conductive auxiliary agent and a binder. The conductive auxiliary agent and the binder are not particularly limited, and known conductive auxiliary agents and the binders used in the negative electrode active material layer of a lithium-ion secondary battery can be used. Furthermore, the negative electrode current collector is not particularly limited, and known negative electrode current collector used in the negative electrode current collector of lithium-ion secondary batteries, such as a copper foil, can be used.

An electrolytic solution includes an organic solvent and an electrolyte. As the organic solvent, for example, cyclic carbonate, chain carbonate, cyclic ether, chain ether, hydrofluoroether, aromatic ether, sulfone, cyclic ester, chain carboxylic acid ester, and nitrile can be used. Examples of the cyclic carbonates include ethylene carbonate, propylene carbonate, vinylene carbonate, fluoroethylene carbonate, and the like. Examples of the chain carbonates include dimethyl carbonate, diethyl carbonate, ethyl methyl carbonate, and the like. Examples of the cyclic ethers include tetrahydrofuran, 2-methyltetrahydrofuran, tetrahydropyran, 1,3-dioxolane, 4-methyl-1,3-dioxolane, and the like. Examples of the chain ethers include 1,2-dimethoxyethane, 1,2-diethoxyethane, ethoxymethoxyethane, diethyl ether, and the like. Examples of the hydrofluoroethers include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl)ether, 1,2-bis(1,1,2,2-tetrafluoroethoxy)ethane, and the like. Example of the aromatic ether includes anisole. Examples of the sulfones include sulfolane, methyl sulfolane, and the like. Examples of the cyclic esters include γ-butyrolactone, and the like. Examples of the chain carboxylic acid esters include acetate esters, butyrate esters, propionate esters, and the like. Examples of the nitriles include acetonitrile, propionitrile, and the like. For the organic solvents, one type may be used alone, or two or more types may be used in combination.

The electrolyte is a supply source of lithium ions which are charge transfer mediums, and includes lithium salts. Examples of the lithium salts include LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI), LiBC₄O₈, and the like. For the lithium salt, one type may be used alone, or two or more types may be used in combination.

As the solid electrolyte, for example, a sulfide solid electrolyte, an oxide solid electrolyte, a nitride solid electrolyte, a halide solid electrolyte, and the like can be used. Examples of the sulfide solid electrolytes include Li₂S—P₂S₅, Li₂S—P₂S₅—LiI, and the like. Examples of the oxide solid electrolyte include NASICON type oxide, garnet type oxide, perovskite type oxide, and the like. Examples of the NASICON type oxides include oxides containing Li, Al, Ti, P, and O (for example, Li_{1.5}Al_{0.5}Ti_{1.5}(PO₄)₃). Examples of the garnet type oxides include oxides containing Li, La, Zr, and O (for example, Li₇La₃Zr₂O₁₂). Examples of the perovskite type oxides include oxides containing Li, La, Ti, and O (for example, LiLaTiO₃).

The separator is not particularly limited, for example, a porous sheet and a nonwoven fabric sheet can be used. Examples of the materials for the porous sheet include polyolefins such as polyethylene and polypropylene, aramid, polyimide, fluorine resins, and the like. Examples of the materials for the nonwoven fabric sheet include glass fibers, cellulose fibers, and the like.

The outer packaging is not particularly limited, and known outer packaging used in lithium-ion secondary batteries, such as metal container or laminated film container, and the like, can be used.

The positive electrode active material for a lithium-ion secondary battery of this embodiment includes a lithium-nickel-manganese composite oxide, and is substantially free of cobalt, so that the sustainability of resources is high. Furthermore, since the surface of the lithium-nickel-manganese composite oxide is coated with a coating layer including boron at the coverage ratio mentioned above, discharge capacity is improved.

In the positive electrode active material for a lithium-ion secondary battery of this embodiment, when the content ratio of boron forming the coating layer is in the range mentioned above, the discharge capacity is reliably improved. According to the positive electrode active material for a lithium-ion secondary battery, when the thickness of the coating layer is in the range mentioned above, the discharge capacity is improved more reliably.

In the positive electrode active material for a lithium-ion secondary battery of this embodiment, when a ratio of the thickness of the coating layer to the average particle diameter of the lithium-nickel-manganese composite oxides is in the range mentioned above, the electric capacity per particle of the lithium-nickel-manganese composite oxide and the thickness of the coating layer are well balanced, and the discharge capacity is further improved.

According to the method for manufacturing a positive electrode active material for a lithium-ion secondary battery of this embodiment, since a mixture containing boric acid in the range mentioned above is calcined, the positive electrode active material for a lithium-ion secondary battery in which the surface of the lithium-nickel-manganese composite oxide is partially coated with the coating layer including boron can be industrially advantageously manufactured. Then, in the resulting positive electrode active material for a lithium-ion secondary battery, since the surface of the lithium-nickel-manganese composite oxide is coated with a coating layer including boron at the coverage ratio mentioned above, the discharge capacity is improved.

In the method for manufacturing a positive electrode active material for a lithium-ion secondary battery of this embodiment, when the calcination temperature of the mixture is in the range mentioned above, the discharge capacity of the resulting positive electrode active material for a lithium-ion secondary battery is reliably improved. In the method for manufacturing a positive electrode active material for a lithium-ion secondary battery of this embodiment, when the temperature rise rate to the calcination temperature is in the range mentioned above, the discharge capacity of the resulting positive electrode active material for a lithium-ion secondary battery is improved more reliably. In the method for manufacturing a positive electrode active material for a lithium-ion secondary battery of this embodiment, when the calcination time of the mixture is in the range mentioned above, the discharge capacity of the resulting positive electrode active material for a lithium-ion secondary battery is improved more reliably.

### EXAMPLES

### Example 1

LiNi_{0.5}Mn_{0.5}O₂ powder having an average primary particle diameter of 4 μm was made ready. To 99.75 g of the LiNi_{0.5}Mn_{0.5}O₂ powder, 0.25 g of boric acid powder was added and mixed using a high-speed agitator mixer (BALANCE GRAN, Freund-Turbo Corporation). The resulting mixture was calcined at 300° C. for 2 hours in an air atmosphere using an electric furnace to obtain a powder calcined product.

### Examples 2 to 3, Comparative Examples 2 to 3

A powder calcined product was obtained in the same manner as in Example 1 except that the amount of LiNi_{0.5}Mn_{0.5}O₂ powder and the adding amount of boric acid powder were as follows. In Example 2, the amount of LiNi_{0.5}Mn_{0.5}O₂ powder was 99.50 g and the adding amount of boric acid powder was 0.50 g. In Example 3, the amount of LiNi_{0.5}Mn_{0.5}O₂ powder was 99.25 g, and the adding amount of boric acid powder was 0.75 g. In Comparative Example 2, the amount of LiNi_{0.5}Mn_{0.5}O₂ powder was 99.00 g, and the adding amount of boric acid powder was 1.00 g. In Comparative Example 3, the amount of LiNi_{0.5}Mn_{0.5}O₂ powder was 97.00 g, and the adding amount of boric acid powder was 3.00 g.

### Comparative Example 1

A powder calcined product was obtained in the same manner as in Example 1 except that LiNi_{0.5}Mn_{0.5}O₂ powder was calcined without adding boric acid powder.

### Evaluation

When the element distribution on the surfaces of the powder calcined products obtained in Examples 1 to 3 and Comparative Examples 1 to 3 were measured using the XPS method, it was observed that surfaces of the powder calcined products obtained in Examples 1 to 3 and Comparative Examples 2 to 3 were coated with a coating layer containing boron. For the powder calcined products obtained in Examples 1 to 3 and Comparative Examples 2 to 3 in which a boron-containing coating layer was observed, the coverage ratio and thickness of the coating layer were measured by the method mentioned above. The results are shown in Table 1 below together with the adding amount of boric acid, calcination temperature, and calcination time in manufacturing of the powder calcined product.

60.0 parts by mass of powder calcined products obtained in Examples 1 to 3 and Comparative Examples 1 to 3, 35.8 parts by mass of sulfide solid electrolyte as a solid electrolyte, 2.9 parts by mass of acetylene black (DENKA BLACK Li-100, manufactured by Denka Company Limited) as a conductive auxiliary agent, and 1.3 parts by mass of SBR (styrene-butadiene rubber) binder were mixed. The resulting mixture was dispersed in a solvent to prepare a positive electrode active material slurry. The resulting positive electrode active material slurry was coated on an aluminum foil (current collector) having a thickness of 12.0 μm and dried to produce a positive electrode material. The resulting positive electrode material (working electrode) and a metallic lithium foil (counter electrode) were immersed in an electrolytic solution in which EC, EMC, and DMC were included at a volume ratio of 3:4:3 and LiPF₆ concentration was 1.2 M to produce a two-electrode cell. The produced 2-electrode cell was charged and discharged under conditions of constant current charging to 4.30 V at 0.1 C and constant current discharging to 2.65 V at a rate of 0.33 C.

TABLE 1

| | | | | Boron-containing | | Positive |
|---|---|---|---|---|---|---|
| | Manufacturing conditions | | | coating film | | electrode |
| | Amount of | Calcination | Calcination | | | discharge |
| | added boric acid | temperature | time | Coverage ratio | Thickness | capacity |
| | (% by mass) | (° C.) | (hour) | (%) | (nm) | (mA/g) |
| Example 1 | 0.25 | 300 | 2.0 | | 11.7 | 149 |
| Example 2 | 0.50 | 300 | 2.0 | 84.2 | 11.9 | 146 |
| Example 3 | 0.75 | 300 | 2.0 | 88.0 | 17.8 | 147 |
| Comparative | — | 300 | 2.0 | — | — | 141 |
| Example 1 | | | | | | |
| Comparative | 1.00 | 300 | 2.0 | 98.5 | 42.5 | 121 |
| Example 2 | | | | | | |
| Comparative | 3.00 | 300 | 2.0 | 90.9 | 42.5 | 78 |
| Example 3 | | | | | | |

From the results of Table 1, it is shown that in the powder calcined products of Examples 1 to 3 obtained by adding boric acid in the range of the present invention to LiNi_{0.5}Mn_{0.5}O₂ powder, followed by calcination, the coverage ratio of the boron-containing coating layer is in the range of the present invention, and the discharge capacity is improved as compared with the powder calcined product of Comparative Example 1 which is not coated with the boron-containing coating layer. This is inferred to be because ion conductive boric acid lithium is generated by the reaction between the surface of the LiNi_{0.5}Mn_{0.5}O₂ powder and boric acid, the resistance of LiNi_{0.5}Mn_{0.5}O₂ powder is lowered. On the other hand, in the powder calcined products of Comparative Examples 2 and 3 obtained by adding boric acid beyond the range of the present invention, followed by calcination, the discharge capacity became lower than the powder calcined product of Comparative Example 1 which is not coated with the boron-containing coating layer. This is inferred to be because with excessive boric acid, unreacted boric acid remains on the surface of LiNi_{0.5}Mn_{0.5}O₂ powder and becomes resistance components to deteriorate discharging property.

### Examples 4 to 7

A powder calcined product was obtained in the same manner as in Example 1 except that the calcination temperature and the calcination time were changed to the conditions shown in Table 2 below. The coverage ratio and thickness of the boron-containing coating layer of the resulting powder calcined product and the discharge capacity were measured in the same manner as the method mentioned above. The results, together with the results of Example 1, are shown in Table 2.

TABLE 2

| | | | | | | Positive |
|---|---|---|---|---|---|---|
| | Manufacturing conditions | | | Boron-containing coating film | | electrode |
| | Amount of added | Calcination | Calcination | Coverage | | discharge |
| | boric acid | temperature | time | ratio | Thickness | capacity |
| | (% by mass) | (° C.) | (hour) | ( %) | (nm) | (mA/g) |
| Example 1 | 0.25 | 300 | 2.0 | 63.1 | 11.7 | 149 |
| Example 4 | 0.25 | 200 | 2.0 | — | — | 145 |
| Example 5 | 0.25 | 500 | 2.0 | 51.4 | 9.5 | 142 |
| Example 6 | 0.25 | 300 | 0.5 | — | — | 144 |
| Example 7 | 0.25 | 300 | 5.0 | 48 | 8.7 | 143 |

From the results of Table 2, it is shown that in the powder calcined products of Examples 4 to 7 obtained under the conditions that the calcination temperature is in the range from 200 to 500° C. and the calcination time is 0.5 to 5.0 hours, similar to the powder calcined product of Example 1, the coverage ratio of the coating layer is in the range of the present invention, and the discharge capacity is improved.

What is claimed is:

1. A positive electrode active material for a lithium-ion secondary battery, the positive electrode active material comprising:
a lithium-nickel-manganese composite oxide comprising lithium, nickel, and manganese, and being substantially free of cobalt; and
a coating layer partially coating a surface of the lithium-nickel-manganese composite oxide,
the coating layer comprising boron, and
the coating layer having a coverage ratio of 40% or more and 90% or less,
wherein the coverage ratio is determined by X-ray photoelectron spectroscopy.

2. The positive electrode active material for a lithium-ion secondary battery according to claim 1, wherein a content ratio of boron is 0.25% by mass or more and less than 0.75% by mass in terms of an amount of boric acid.

3. The positive electrode active material for a lithium-ion secondary battery according to claim 1, wherein the coating layer includes boric acid.

4. The positive electrode active material for a lithium-ion secondary battery according to claim 1, wherein the coating layer has a thickness of 5.0 nm or more and 20.0 nm or less.

5. The positive electrode active material for a lithium-ion secondary battery according to claim 1, wherein the lithium-nickel-manganese composite oxide has an average particle diameter of 3 μm or more and 5 μm or less.

6. The positive electrode active material for a lithium-ion secondary battery according to claim 1, wherein a ratio of a thickness of the coating layer to an average particle diameter of the lithium-nickel-manganese composite oxide is 0.001 or more and 0.014 or less.

7. The positive electrode active material for a lithium-ion secondary battery according to claim 1, wherein an amount of hydrochloric acid at 0.05 mol/L required to neutralize a mixture solution obtained by putting 1 g of the positive electrode active material into 50 mL of water is 1.8 mL or more and 2.9 mL or less.

8. A method for manufacturing a positive electrode active material for a lithium-ion secondary battery, the method comprising
calcining a mixture that contains a lithium-nickel-manganese composite oxide comprising lithium, nickel, and manganese, and being substantially free of cobalt, and boric acid such that a content of boric acid is 0.25% by mass or more and less than 0.75% by mass.

9. The method for manufacturing a positive electrode active material for a lithium-ion secondary battery according to claim 8, the mixture is calcined at a calcination temperature of 200° C. or higher and 500° C. or lower.

10. The method for manufacturing a positive electrode active material for a lithium-ion secondary battery according to claim 9, wherein heating is carried out to the calcination temperature at a temperature rise rate of 5° C./minute or greater and 20° C./minute or less.

11. The method for manufacturing a positive electrode active material for a lithium-ion secondary battery according to claim 8, wherein the mixture is calcined for a calcination time of 0.5 hours or longer and 5.0 hours or shorter.
